(19) United States
(12) Patent Application Publication
(10) Pub. No.: US 2007/0115434 A1
(43) Pub. Date: May 24, 2007

(54) External ornament for vehicle and vehicle including external ornament

(75) Inventors: Tatsuya Oba, Aichi-ken (JP); Tetsuya Fujii, Aichi-ken (JP); Chiharu Totani, Aichi-ken (JP)

Correspondence Address: POSZ LAW GROUP, PLC, 12040 SOUTH LAKES DRIVE, SUITE 101, RESTON, VA, 20191, US

(73) Assignee: TOYODA GOSEI CO., LTD., Aichi-ken (JP)

(21) Appl. No.: 11/594,971

(22) Filed: Nov. 9, 2006

(30) Foreign Application Priority Data
Nov. 10, 2005 (JP) 2005-326054

(51) Int. Cl. G03B 21/00

(52) U.S. Cl. 352/243

(57) ABSTRACT

A radiator grille for a vehicle equipped with an in-vehicle camera that captures images outside the vehicle. The radiator grille includes a base material made of a transparent resin. A thick portion is formed integrally with the base material. The thick portion is arranged outward from the in-vehicle camera and functions as a lens of the in-vehicle camera.

### BACKGROUND OF THE INVENTION

The present invention relates to an external ornament for attachment to a vehicle including an in-vehicle camera for capturing images outside the vehicle. The present invention also relates to a vehicle including an external ornament.

Japanese Laid-Open Patent Publication No. 2003-159997 discloses a mounting structure for a camera arranged in a vehicle to ensure the view in front of the vehicle. The camera is projected forward from the front of the vehicle to captures images of a wide view in front of the vehicle. The camera mounting structure includes a drive device, a first arm connected to the drive device, and a second arm connected to the first arm. This structure enables the camera to be projected forward from the front of the vehicle.

The camera mounting structure does not transmit the drive force of the drive device through a rack and pinion engagement to move the camera. Thus, the moving mechanism of the camera is not affected by dust. This improves the reliability of the camera. Further, when not in use, the camera is hidden behind an emblem. When using the camera, the emblem is moved so as to enable the camera to be projected forward.

The inventors of the present invention have researched and developed an in-vehicle camera mounting structure having a high aesthetic appeal and enabling images to be captured without using a complicated structure such as that disclosed in Japanese Laid-Open Patent Publication No. 2003-159997.

### SUMMARY OF THE INVENTION

It is an object of the present invention to provide an external ornament for a vehicle having a high aesthetic appeal while enabling an in-vehicle camera to capture images. It is also an object of the present invention to provide a vehicle including an external ornament.

One aspect of the present invention is an external ornament for a vehicle equipped with an in-vehicle camera for capturing images outside the vehicle. The external ornament includes a base material made of a transparent resin. A thick portion is formed integrally with the base material. The thick portion is arranged outward from the in-vehicle camera and functions as a lens of the in-vehicle camera.

Another aspect of the present invention is a vehicle including an in-vehicle camera for capturing images outside the vehicle and an external ornament. The external ornament includes a base material made of a transparent resin and a thick portion formed integrally with the base material. The thick portion is arranged outward from the in-vehicle camera and functions as a lens of the in-vehicle camera.

Other aspects and advantages of the present invention will become apparent from the following description, taken in conjunction with the accompanying drawings, illustrating by way of example the principles of the invention.

### BRIEF DESCRIPTION OF THE DRAWINGS

The invention, together with objects and advantages thereof, may best be understood by reference to the following description of the presently preferred embodiments together with the accompanying drawings in which:

FIG. 1 is a perspective view showing the front of a vehicle according to a preferred embodiment of the present invention;

FIG. 2 is a front view showing a radiator grille;

FIG. 3 is a cross-sectional diagram taken along line 3-3 in FIG. 2;

FIG. 4A is a cross-sectional diagram showing a radiator grille with a thick portion according to another embodiment of the present invention; and

FIG. 4B is a cross-sectional diagram showing a radiator grille with a thick portion according to a further embodiment of the present invention.

### DETAILED DESCRIPTION OF THE PREFERRED EMBODIMENTS

An external ornament for a vehicle according to the present invention and embodied in a radiator grille will now be discussed with reference to the drawings. In the following description, the upper and lower directions from the radiator grille correspond to the upper and lower directions indicated by arrow Y1 shown in FIG. 2 and extending in the vertical direction. Further, the right and left directions from the radiator grille correspond to the right and left directions indicated by arrow Y2 shown in FIG. 2 and extending in the lateral direction. Further, the forward direction from the radiator grille corresponds to the traveling direction of the vehicle, and the rearward direction from the radiator grille corresponds to the reverse direction of the vehicle.

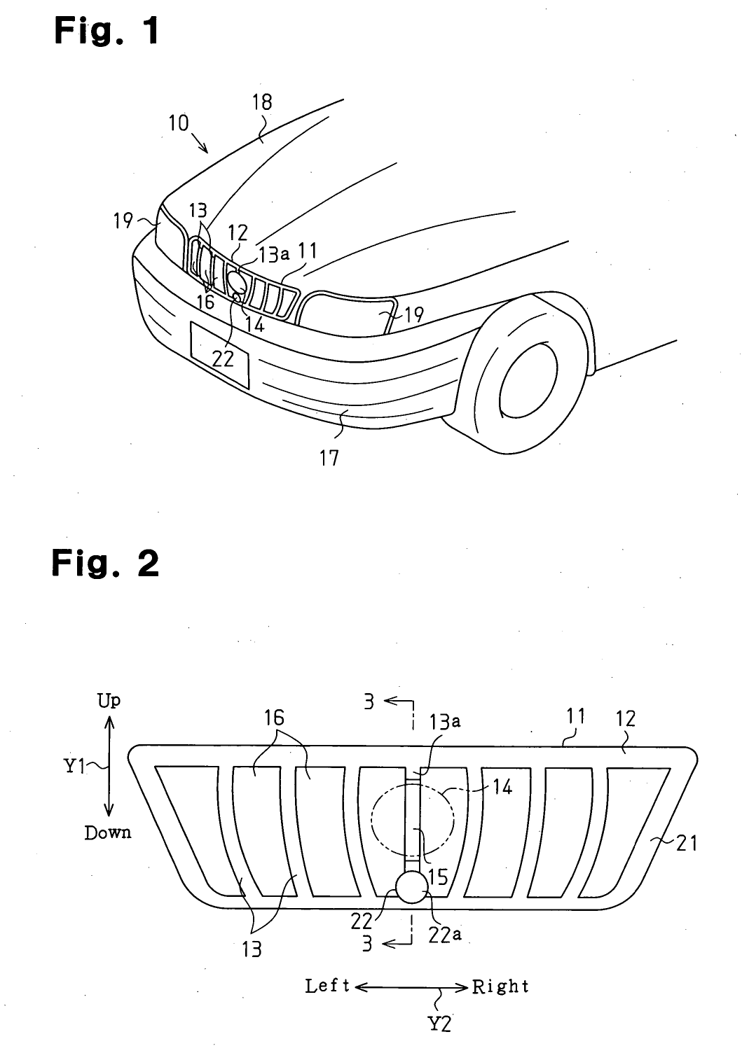

As shown in FIGS. 1 and 2, a radiator grille 11, which is also referred to as a front grille, is arranged at the front of a vehicle 10 and in front of a radiator (not shown). More specifically, the radiator grille 11 is arranged between a front bumper 17 and a hood 18 of the vehicle 10 and located between two headlights 19.

Referring to FIG. 2, the radiator grille 11 includes a rectangular outer frame 12 elongated in the lateral direction and having a predetermined width. A plurality of vertical bars 13 connect the upper and lower sides of the outer frame 12. The vertical bars 13 are formed integrally with the outer frame 12. A vertical bar 13a located in the middle of the radiator grille 11 includes a recess 15 for receiving an emblem 14, which is an elliptic plate.

In the radiator grille 11, a plurality of slits 16 are defined between the left and right sides of the outer frame 12 and the vertical bars 13. Further, the radiator grille 11 is streamlined and extends diagonally from the front bumper 17 to the hood 18 of the vehicle. The streamlined form of the radiator grille 11 makes the vehicle look sporty and luxurious.

The front side of the vehicle around the radiator grille 11 is the portion that gives a strong impression of the vehicle. In other words, the front side of the vehicle corresponds to the face of a person and is an extremely important portion that distinguishes the vehicle from other vehicles. Thus, the aesthetic appeal of the vehicle 10 is important, and the front surface of the radiator grille 11 plays an important role in improving the aesthetic appeal. The front surfaces of the outer frame 12 and vertical bars 13 forming the front surface of the radiator grille 11 function as an ornamental surface of the radiator grille 11.

The radiator grille 11 is transparent and formed by a base material 21 made of polycarbonate. The base material 21 forms the outer frame 12 and the vertical bars 13. Polycarbonate resin is a transparent resin that enables the transmission of visible light. Further, polycarbonate resin is provided with superior light and weather resistance properties and has a high refractive index. The base material 21 is solid and formed by injection molding polycarbonate resin, which resembles glass.

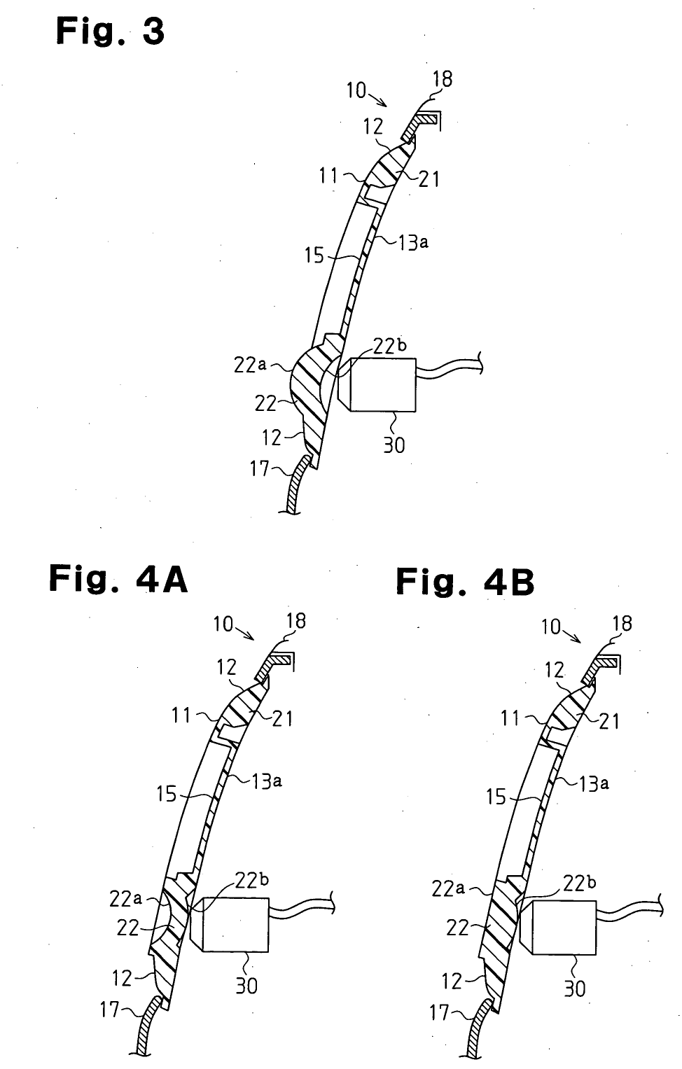

Referring to FIGS. 2 and 3, in the base material 21, a thick portion 22 is formed integrally with the vertical bar 13a. The thick portion 22, which is located below the recess 15, has a round shape when viewed from the front of the vehicle 10 (radiator grille 11). Further, the thick portion 22 is thicker than the vertical bars 13 and the outer frame 12. The thick portion 22 has an exposed surface that defines a front surface 22a extending to the lower side of the outer frame 12. The front surface 22a bulges in a curved manner toward the front of the vehicle 10. The front surface 22a of the thick portion 22 is in conformity and integrity with the front surface of the vertical bar 13a and forms part of the ornamental surface of the radiator grille 11. That is, the front surface 22a of the thick portion 22 is formed along the ornamental surface of the radiator grille 11.

As shown in FIG. 3, the middle part of the thick portion 22 is most projected toward the front. The thick portion 22 is curved from the middle part to the circumferential part of the front surface 22a. Further, the thick portion 22 has a rear surface 22b curved inwardly toward the front. The thick portion 22 is curved from the middle part to the circumferential part of the rear surface 22b. The thick portion 22 is thickest at the middle part and gradually becomes thin toward the circumferential part.

The thick portion 22 is shaped into a convex lens (in the preferred embodiment, meniscus lens) in which the middle part is thicker than the circumferential part. The convex lens functions to converge parallel light and generate an image at the converging point. The thick portion 22 functions as a wide-angle lens. As a result, the view in front of the thick portion 22 is generated as an image inward from the thick portion 22 in the vehicle.

Referring to FIG. 1, in a state in which the radiator grille 11 is arranged at the front of the vehicle 10, the thick portion 22 is located under the emblem 14 and above the lower side of the outer frame 12. The upper side of the outer frame 12, the emblem 14, the thick portion 22, and the lower side of the outer frame 12 are arranged from the upper portion to the lower portion at the front of the vehicle 10. The front of the vehicle 10 is partially transparent like glass at the radiator grille 11.

As shown in FIG. 3, an in-vehicle camera 30 is arranged behind the thick portion 22 of the radiator grille 11. The in-vehicle camera 30 is arranged in the vehicle 10 at a location corresponding to the thick portion 22. The thick portion 22 is arranged outward from the in-vehicle camera to function as the lens for the in-vehicle camera 30. The thick portion 22 bulges outwardly.

In the vehicle 10 equipped with the in-vehicle camera 30, the base material 21 forming the radiator grille 11 is made of a transparent polycarbonate resin, and the thick portion 22 functions as a lens (wide-angle lens in the present embodiment). The thick portion 22 forms an image of the view in front of and around (in the vertical and lateral directions of) the thick portion 22. Then, the in-vehicle camera 30 captures the image in front of (outside) the vehicle 10 formed by the thick portion 22. This image is shown on a monitor (e.g., screen of a navigation system) in the passenger compartment.

The above embodiment has the advantages described below.

The radiator grille 11 is formed by the base material 21, which is made of a transparent polycarbonate resin. The thick portion 22, which functions as a lens (wide-angle lens) of the in-vehicle camera 30, is formed integrally with the base material 21. The thick portion 22 forms a wide-angle image of the view in front of (outside) the vehicle so that the in-vehicle camera 30 captures a satisfactory view. The in-vehicle camera 30 does not have to be projected toward the front of the vehicle 10 to capture an image of the view in front of the vehicle 10. Thus, a satisfactory view of the front of the vehicle 10 is captured with a simple structure that does not use a projection mechanism.

If a component functioning as a lens of the in-vehicle camera 30 were to be formed separately from the base material 21, the lens and the radiator grille 11 may have different colors. In such a case, the radiator grille 11 would appear as not having integrity. However, in the above embodiment, the thick portion 22 is formed integrally with the base material 21. Thus, the ornamental surface (front surface) of the radiator grille 11 has integrity. Further, the front surface 22a of the thick portion 22 is formed in conformation with the vertical bars 13a and the outer frame 12. Thus, the radiator grille 11 has a high aesthetic appeal. In the background art, when using a camera, the emblem (corresponding to the emblem 14 of the present embodiment) is moved so as to enable the camera to be projected forward. However, in the present embodiment, when using the in-vehicle camera 30, the ornamental surface of the radiator grille 11 including the thick portion 22 does not change. This prevents the aesthetic appeal of the radiator grille 11, or the front of the vehicle 10, from being reduced since the camera is not projected.

The radiator grille 11 is arranged at the front of the vehicle 10, that is, the portion of the vehicle 10 that distinguishes the vehicle 10 from other vehicles. The radiator grille 11 including the thick portion 22 is transparent like glass. Thus, in comparison with a typical radiator grille that is painted and colored, the radiator grille 11 has a high aesthetic appeal and makes the vehicle 10 impressive.

The radiator grille 11 is formed by the base material 21, which is injection molded into a solid from polycarbonate resin (transparent resin). The base material 21 has the desired shape that is obtained in accordance with the shape of the molds used during injection molding. In the present embodiment, the thick portion 22 is molded on the base material 21 at a location that is optimal for arranging the in-vehicle 30 at the front of the vehicle 10. Accordingly, by injection molding the radiator grille 11 from polycarbonate resin, the freedom of design of the radiator grille 11 is drastically increased.

If the thick portion 22 were to be, for example, formed toward one side of the vehicle 10, the view captured by the in-vehicle camera 30 would be biased to that side. However, in the present embodiment, the thick portion 22 is formed in the laterally middle part of the vehicle 10. Thus, the view captured by the in-vehicle camera 30 is not biased to one side of the vehicle. As a result, the in-vehicle camera 30 captures an image of a view having balanced sides.

The thick portion 22 is shaped into a convex lens that bulges toward the front of the vehicle 10. The ornamental surface of the radiator grille 11 is formed by portions that continuously bulge toward the front of the vehicle 10. These portions include the upper side of the outer frame 12, the emblem 14, the front surface 22a of the thick portion 22, and the lower side of the outer frame 12. Due to the continuously bulged portions, the radiator grille 11 looks integral. As a result, the radiator grille 11 has a high aesthetic appeal.

The thick portion 22 is shaped into a convex lens. Thus, the in-vehicle camera 30 captures a view of the entire surrounding of the thick portion 22, and the view in front of the vehicle 10 can be displayed with a single picture on the monitor in the passenger compartment. This makes the monitor easy to see in comparison to when the view in front of the vehicle 10 is shown divided into two pictures on the left and right sides of the monitor, such as when using a prism as the lens of the in-vehicle camera 30.

It should be apparent to those skilled in the art that the present invention may be embodied in many other specific forms without departing from the spirit or scope of the invention. Particularly, it should be understood that the present invention may be embodied in the following forms.

As shown in FIG. 4A, the thick portion 22 may be shaped into a concave meniscus lens that bulges inwardly into the vehicle 10.

As shown in FIG. 4B, the thick portion 22 may be shaped into a plano-convex lens having a flat front surface 22a, which is exposed to the front of the vehicle 10, and a rear surface 22b curved and bulged toward the rear. Further, the thick portion 22 may be shaped into a double convex lens, a double concave lens, or a plano-concave lens. That is, as long as the thick portion 22 functions as a lens of the in-vehicle camera 30 and forms an image of the view outside the vehicle 10 that can be captured by the in-vehicle camera 30, the thick portion 22 may have any shape and may be changed in any manner.

The vehicle external ornament may be embodied in a rear garnish. In this case, a thick portion may be formed in the rear garnish to function as a lens of a rear camera (in-vehicle camera).

The vehicle external ornament may be embodied in a roof end spoiler. In this case, a thick portion may be formed in the roof end spoiler to function as a lens of a rear camera (in-vehicle camera).

In the radiator grille 11, portions other than the thick portion 22 may be painted.

The thick portion 22 may be shaped into a prism.

The present examples and embodiments are to be considered as illustrative and not restrictive, and the invention is not to be limited to the details given herein, but may be modified within the scope and equivalence of the appended claims.

What is claimed is:

1. An external ornament for a vehicle equipped with an in-vehicle camera for capturing images outside the vehicle, the external ornament comprising:
a base material made of a transparent resin; and
a thick portion formed integrally with the base material, wherein the thick portion is arranged outward from the in-vehicle camera and functions as a lens of the in-vehicle camera.

2. The external ornament according to claim 1, wherein:
the vehicle has a front having a predetermined width;
the external ornament is a radiator grille arranged on the front of the vehicle; and
the thick portion is arranged at a middle part of the vehicle with respect to the width of the vehicle.

3. The external ornament according to claim 1, wherein the thick portion is shaped into an outwardly bulging convex lens.

4. The external ornament according to claim 1, wherein the vehicle has an interior, and the thick portion is shaped into a concave meniscus lens bulging toward the interior of the vehicle.

5. The external ornament according to claim 1, wherein the thick portion is shaped into a plano-convex lens having an outwardly exposed flat surface and a surface bulging into the vehicle.

6. The external ornament according to claim 1, wherein the thick portion functions as a wide-angle lens.

7. The external ornament according to claim 2, wherein the radiator grille has an ornamental surface, the thick portion has a surface exposed to the outside, and the surface of the thick portion is formed along the ornamental surface of the radiator grille.

8. The external ornament according to claim 1, wherein the transparent resin is polycarbonate.

9. A vehicle comprising:
an in-vehicle camera for capturing images outside the vehicle; and
an external ornament including:
a base material made of a transparent resin; and
a thick portion formed integrally with the base material, wherein the thick portion is arranged outward from the in-vehicle camera and functions as a lens of the in-vehicle camera.
